(19) United States
(12) Patent Application Publication
(10) Pub. No.: US 2026/0025498 A1
(43) Pub. Date: Jan. 22, 2026

(54) SPATIAL RESAMPLING IN VIDEO CODING AND DECODING SYSTEMS

(71) Applicant: Tencent America LLC, Palo Alto, CA (US)

(72) Inventors: Shan LIU, San Jose, CA (US); Roman CHERNYAK, Santa Clara, CA (US); Motong XU, Palo Alto, CA (US)

(73) Assignee: Tencent America LLC, Palo Alto, CA (US)

(21) Appl. No.: 19/191,040

(22) Filed: Apr. 28, 2025

Related U.S. Application Data
(60) Provisional application No. 63/672,207, filed on Jul. 16, 2024.

(51) Int. Cl. H04N 19/117; H04N 19/172; H04N 19/70; H04N 19/80

(52) U.S. Cl. CPC H04N 19/117; H04N 19/172; H04N 19/70; H04N 19/80

(57) ABSTRACT

This disclosure relates generally to video coding/decoding and particularly for spatial downsampling and/or resampling in video coding and/or decoding systems. One method includes obtaining, by a device, a coded video bitstream; determining, by the device from the coded video bitstream, a spatial resampling flag for a picture frame; and when the spatial resampling flag indicates that spatial resampling is enabled for the picture frame: determining, by the device from the coded video bitstream, an index indicating a spatial resampling filter, and decoding, by the device, the coded video bitstream by generating spatial resampling data based on the spatial resampling filter.

### INCORPORATION BY REFERENCE

This application is based on and claims the benefit of priority to U.S. Provisional Application No. 63/672,207 filed on Jul. 16, 2024, which is herein incorporated by reference in its entirety.

### TECHNICAL FIELD

This disclosure describes a set of advanced video/streaming coding/decoding technologies. More specifically, the disclosed technology involves spatial downsampling and/or resampling in some video coding or decoding systems.

### BACKGROUND

Uncompressed digital video can include a series of pictures, and may specific bitrate requirements for storage, data processing, and for transmission bandwidth in streaming applications. One purpose of video coding and decoding can be the reduction of redundancy in the uncompressed input video signal, through various compression techniques.

With the rise of machine learning applications, along with the abundance of sensors, many intelligent platforms have utilized video for machine vision tasks such as object detection, segmentation, and/or tracking. As a result, encoding video or images for consumption by machine tasks has become an interesting and challenging problem. This has led to the introduction of Video Coding for Machines (VCM) studies.

While the various embodiments in the present disclosure are described in the context of VCM, the underlying principles are generally applicable other video coding systems.

### SUMMARY

The present disclosure describes various embodiments of methods, apparatus, and computer-readable storage medium for improvement of spatial downsampling and/or resampling in video coding and/or decoding systems.

According to one aspect, an embodiment of the present disclosure provides a method for decoding a coded video bitstream. The method includes obtaining, by a device, a coded video bitstream. The device includes a memory storing instructions and a processor in communication with the memory. The method also includes determining, by the device from the coded video bitstream, a spatial resampling flag for a picture frame; and when the spatial resampling flag indicates that spatial resampling is enabled for the picture frame: determining, by the device from the coded video bitstream, an index indicating a spatial resampling filter, and decoding, by the device, the coded video bitstream by generating spatial resampling data based on the spatial resampling filter.

According to another aspect, an embodiment of the present disclosure provides a method for encoding a video. The method includes obtaining, by a device, a video. The device includes a memory storing instructions and a processor in communication with the memory. The method also includes determining, by the device based on the video, a spatial resampling flag for a picture frame; encoding, by the device, the spatial resampling flag into a coded video bitstream; and when the spatial resampling flag indicates that spatial resampling is enabled for the picture frame: determining, by the device based on the video, an index indicating a spatial resampling filter, encoding, by the device, the index into a coded video bitstream, and encoding, by the device, the video into the coded video bitstream by downsampling based on the spatial resampling filter.

According to another aspect, an embodiment of the present disclosure provides a method for creating and/or storing and/or transmitting and/or decoding an encoded bitstream of a video. The encoded bitstream may include a spatial resampling flag for a picture frame; and when the spatial resampling flag indicates that spatial resampling is enabled for the picture frame, an index indicating a spatial resampling filter, so that the encoded bitstream is configured to be decoded by generating spatial resampling data based on the spatial resampling filter.

According to another aspect, an embodiment of the present disclosure provides an apparatus. The apparatus includes a memory storing instructions; and a processor in communication with the memory. When the processor executes the instructions, the processor is configured to cause the apparatus to perform any method as described above and/or elsewhere in the present disclosure.

In another aspect, an embodiment of the present disclosure provides non-transitory computer-readable mediums storing instructions, which, when executed by a computer, cause the computer to perform any method as described above and/or elsewhere in the present disclosure.

The above and other aspects and their implementations are described in greater detail in the drawings, the descriptions, and the claims.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a schematic illustration of an example computer system in accordance with an embodiment.

FIG. 3 is a block diagram of an example architecture for performing video coding, according to embodiments.

FIG. 4 shows a schematic illustration of a simplified block diagram of a video encoder in accordance with an example embodiment;

FIG. 5 shows a block diagram of a video encoder in accordance with another example embodiment;

FIG. 6 shows a block diagram of a video decoder in accordance with another example embodiment;

FIG. 7 shows a scheme of spatial resampling-based video compression framework according to example embodiments of the disclosure;

FIG. 8 shows a schematic diagram of spatial downsampling according to example embodiments of the disclosure;

FIG. 9 shows a schematic diagram of spatial upsampling (or resampling) according to example embodiments of the disclosure;

FIG. 10 shows an example logic flow for a method in the present disclosure;

FIG. 11 shows an example logic flow for another method in the present disclosure.

### DETAILED DESCRIPTION OF EMBODIMENTS

The invention will now be described in detail hereinafter with reference to the accompanied drawings, which form a part of the present invention, and which show, by way of illustration, specific examples of embodiments. Please note that the invention may, however, be embodied in a variety of different forms and, therefore, the covered or claimed subject matter is intended to be construed as not being limited to any of the embodiments to be set forth below. Please also note that the invention may be embodied as methods, devices, components, or systems. Accordingly, embodiments of the invention may, for example, take the form of hardware, software, firmware or any combination thereof.

Throughout the specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

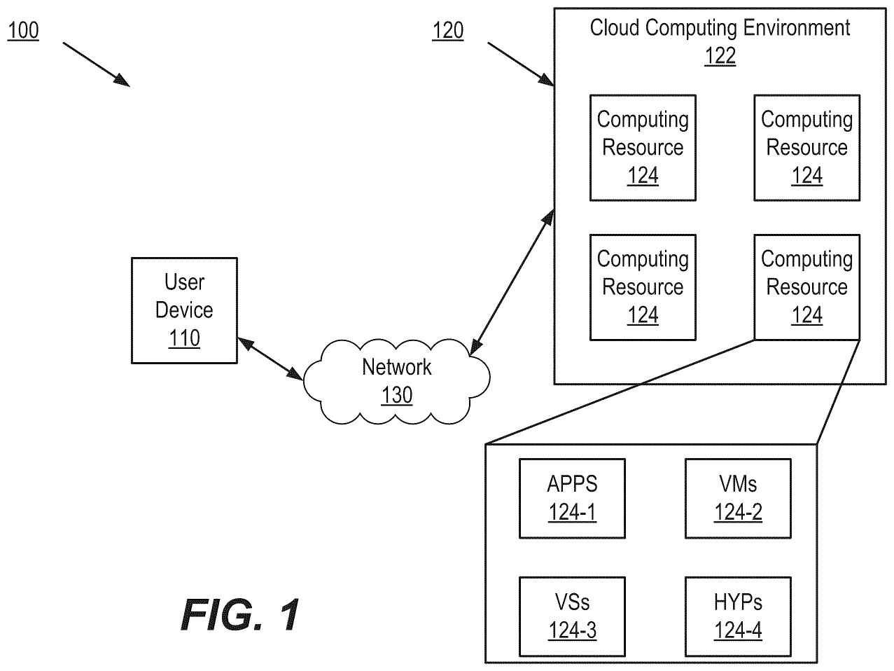

FIG. 1 is a diagram of an application environment 100 in which methods, apparatuses, and systems described herein may be implemented, according to the example embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown in FIG. 1, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a sixth generation (6G) or newer network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

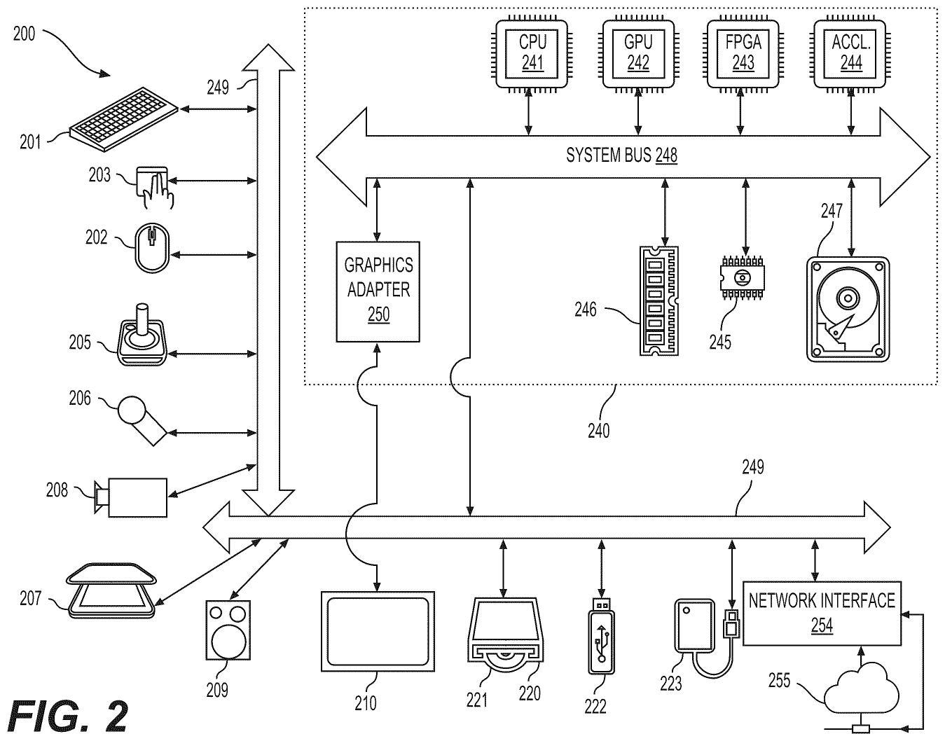

The techniques and implementations described below can be implemented as computer software using computer-readable instructions and physically stored in one or more computer-readable media. For example, FIG. 2 shows a computer system (200) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 2 for computer system (200) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (200).

Computer system (200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (201), mouse (202), trackpad (203), touch screen (210), data-glove (not shown), joystick (205), microphone (206), scanner (207), camera (208).

Computer system (200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (210), data-glove (not shown), or joystick (205), but there can also be tactile feedback devices that do not serve as input devices), audio output devices (such as: speakers (209), headphones (not depicted)), visual output devices (such as screens (210) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (200) can also include human accessible storage devices and their associated media such as optical media including CD/DVD ROM/RW (220) with CD/DVD or the like media (221), thumb-drive (222), removable hard drive or solid state drive (223), legacy magnetic media such as tape and floppy disc (not depicted), specialized ROM/ASIC/PLD based devices such as security dongles (not depicted), and the like. Those skilled in the art should also understand that term “computer readable media” as used in connection with the presently disclosed subject matter does not encompass transmission media, carrier waves, or other transitory signals.

Computer system (200) can also include an interface (254) to one or more communication networks (255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general-purpose data ports or peripheral buses (249) (such as, for example USB ports of the computer system (200)); others are commonly integrated into the core of the computer system (200) by attachment to a system bus as described below (for example Ethernet interface into a PC computer system or cellular network interface into a smartphone computer system). Using any of these networks, computer system (200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (240) of the computer system (200).

The core (240) can include one or more Central Processing Units (CPU) (241), Graphics Processing Units (GPU) (242), specialized programmable processing units in the form of Field Programmable Gate Areas (FPGA) (243), hardware accelerators for certain tasks (244), graphics adapters (250), and so forth. These devices, along with Read-only memory (ROM) (245), Random-access memory (246), internal mass storage such as internal non-user accessible hard drives, SSDs, and the like (247), may be connected through a system bus (248). In some computer systems, the system bus (248) can be accessible in the form of one or more physical plugs to enable extensions by additional CPUs, GPU, and the like. The peripheral devices can be attached either directly to the core's system bus (248), or through a peripheral bus (249). In an example, the screen (210) can be connected to the graphics adapter (250). Architectures for a peripheral bus include PCI, USB, and the like.

CPUs (241), GPUs (242), FPGAs (243), and accelerators (244) can execute certain instructions that, in combination, can make up the aforementioned computer code. That computer code can be stored in ROM (245) or RAM (246). Transitional data can be also be stored in RAM (246), whereas permanent data can be stored for example, in the internal mass storage (247). Fast storage and retrieve to any of the memory devices can be enabled through the use of cache memory, that can be closely associated with one or more CPU (241), GPU (242), mass storage (247), ROM (245), RAM (246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (200), and specifically the core (240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (240) that are of non-transitory nature, such as core-internal mass storage (247) or ROM (245). The software implementing various embodiments of the present disclosure can be stored in such devices and executed by core (240). A computer-readable medium can include one or more memory devices or chips, according to particular needs. The software can cause the core (240) and specifically the processors therein (including CPU, GPU, FPGA, and the like) to execute particular processes or particular parts of particular processes described herein, including defining data structures stored in RAM (246) and modifying such data structures according to the processes defined by the software. In addition, or as an alternative, the computer system can provide functionality as a result of logic hardwired or otherwise embodied in a circuit (for example: accelerator (244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

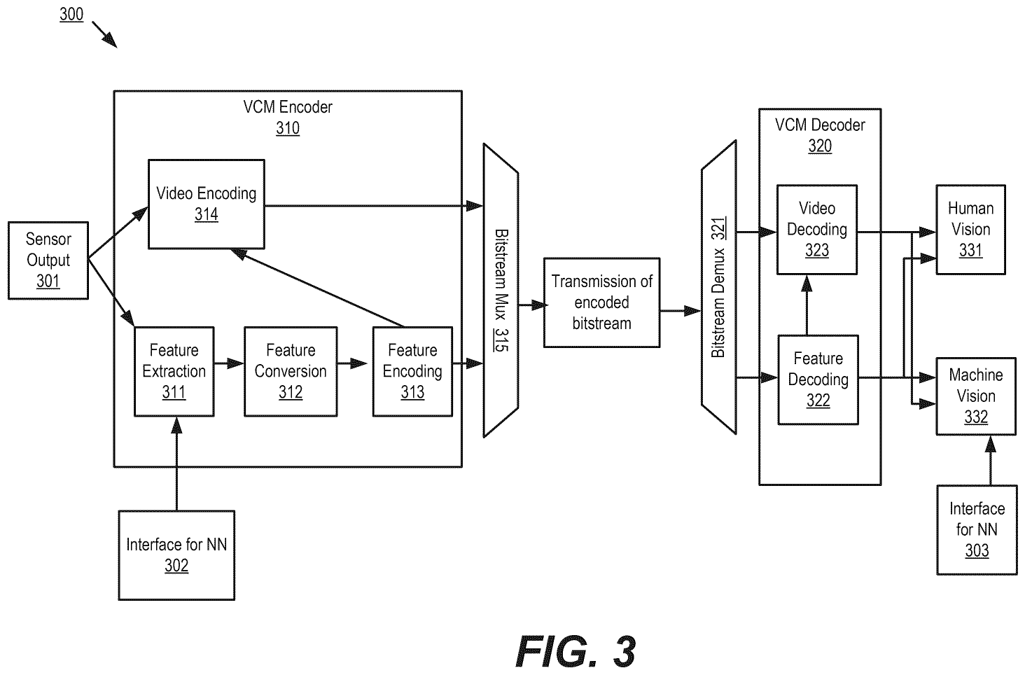

FIG. 3 is a block diagram of an example architecture 300 for performing video coding, according to embodiments. In embodiments, the architecture 300 may be a video coding for machines (VCM) architecture, or an architecture that is otherwise compatible with or configured to perform VCM coding. For example, architecture 300 may be compatible with “Use cases and requirements for Video Coding for Machines” (ISO/IEC JTC 1/SC 29/WG 2 N18), “Draft of Evaluation Framework for Video Coding for Machines” (ISO/IEC JTC 1/SC 29/WG 2 N19), and “Call for Evidence for Video Coding for Machines” (ISO/IEC JTC 1/SC 29/WG 2 N20), the disclosures of which are incorporated by reference herein in their entireties.

In embodiments, one or more of the elements illustrated in FIG. 3 may correspond to, or be implemented by, one or more of the elements discussed above with respect to FIGS. 1-2, for example one or more of the user device 110, the platform 120, the device 200, or any of the elements included therein.

As can be seen in FIG. 3, the architecture 300 may include a VCM encoder 310 and a VCM decoder 320. In some example embodiments, the VCM encoder may receive sensor input 301, which may include for example one or more input images, or an input video. The sensor input 301 may be provided to a feature extraction module 311 which may extract features from the sensor input, and the extracted features may be converted using feature conversion module 312, and encoded using feature encoding module 313. In embodiments, the term “encoding” may include, may correspond to, or may be used interchangeably with, the term “compressing”. The architecture 300 may include an interface 302, which may allow the feature extraction module 311 to interface with a neural network (NN) which may assist in performing the feature extraction.

The sensor input 301 may be provided to a video encoding module 314, which may generate an encoded video. In some example embodiments, after the features are extracted, converted, and encoded, the encoded features may be provided to the video encoding module 314, which may use the encoded features to assist in generating the encoded video. In embodiments, the video encoding module 314 may output the encoded video as an encoded video bitstream, and the feature encoding module 313 may output the encoded features as an encoded feature bitstream. In embodiments, the VCM encoder 310 may provide both the encoded video bitstream and the encoded feature bitstream to a bitstream multiplexer 315, which may generate an encoded bitstream by combining the encoded video bitstream and the encoded feature bitstream.

In embodiments, the encoded bitstream may be received by a bitstream demultiplexer (demux), which may separate the encoded bitstream into the encoded video bitstream and the encoded feature bitstream, which may be provided to the VCM decoder 320. The encoded feature bitstream may be provided to the feature decoding module 322, which may generate decoded features, and the encoded video bitstream may be provided to the video decoding module, which may generate a decoded video. In embodiments, the decoded features may also be provided to the video decoding module 323, which may use the decoded features to assist in generating the decoded video.

In embodiments, the output of the video decoding module 323 and the feature decoding module 322 may be used mainly for machine consumption, for example machine vision module 332. In embodiments, the output can also be used for human consumption, illustrated in FIG. 3 as human vision module 331. A VCM system, for example the architecture 300, from the client end, for example from the side of the VCM decoder 320, may perform video decoding to obtain the video in the sample domain first. Then one or more machine tasks to understand the video content may be performed, for example by machine vision module 332. In embodiments, the architecture 300 may include an interface 303, which may allow the machine vision module 332 to interface with an NN which may assist in performing the one or more machine tasks.

As can be seen in FIG. 3, in addition to a video encoding and decoding path, which includes the video encoding module 314 and the video decoding module 323, another path included in the architecture 300 may be a feature extraction, feature encoding, and feature decoding path, which includes the feature extraction module 311, the feature conversion module 312, the feature encoding module 313, and the feature decoding module 322.

Embodiments may relate to methods for enhancing decoded video for machine vision, human vision, or human/machine hybrid vision. In embodiments, each decoded image, which may be generated for example by the VCM decoder 320, may be enhanced for machine vision or human vision using an enhancement module and metadata sent from the encoder side. In embodiments, these methods can be applied to any VCM codec. Although some embodiments may be described using broader terms such as “image/video,” or using more specific terms such as “image” and “video”, it may be understood that embodiments may be applied.

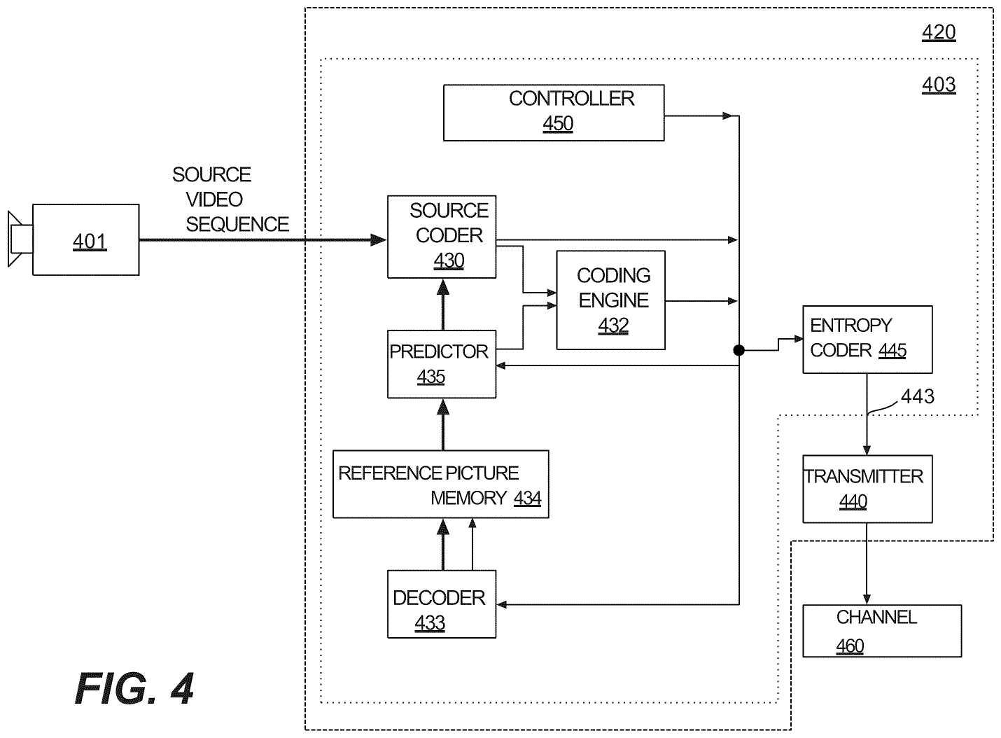

FIG. 4 shows a block diagram of a video encoder (403) according to an example embodiment of the present disclosure. The video encoder (403) may be included in an electronic device (420). The electronic device (420) may further include a transmitter (440) (e.g., transmitting circuitry).

The video encoder (403) may receive video samples from a video source (401). According to some example embodiments, the video encoder (403) may code and compress the pictures of the source video sequence into a coded video sequence (443) in real time or under any other time constraints as required by the application. Enforcing appropriate coding speed constitutes one function of a controller (450). In some embodiments, the controller (450) may be functionally coupled to and control other functional units as described below. Parameters set by the controller (450) can include rate control related parameters (picture skip, quantizer, lambda value of rate-distortion optimization techniques, . . . ), picture size, group of pictures (GOP) layout, maximum motion vector search range, and the like.

In some example embodiments, the video encoder (403) may be configured to operate in a coding loop. The coding loop can include a source coder (430), and a (local) decoder (433) embedded in the video encoder (403). The decoder (433) reconstructs the symbols to create the sample data in a similar manner as a (remote) decoder would create even though the embedded decoder 433 process coded video steam by the source coder 430 without entropy coding (as any compression between symbols and coded video bitstream in entropy coding may be lossless in the video compression technologies considered in the disclosed subject matter).

During operation in some example implementations, the source coder (430) may perform motion compensated predictive coding, which codes an input picture predictively with reference to one or more previously coded picture from the video sequence that were designated as “reference pictures.”

The local video decoder (433) may decode coded video data of pictures that may be designated as reference pictures. The local video decoder (433) replicates decoding processes that may be performed by the video decoder on reference pictures and may cause reconstructed reference pictures to be stored in a reference picture cache (434). In this manner, the video encoder (403) may store copies of reconstructed reference pictures locally that have common content as the reconstructed reference pictures that will be obtained by a far-end (remote) video decoder (absent transmission errors).

The predictor (435) may perform prediction searches for the coding engine (432). That is, for a new picture to be coded, the predictor (435) may search the reference picture memory (434) for sample data (as candidate reference pixel blocks) or certain metadata such as reference picture motion vectors, block shapes, and so on, that may serve as an appropriate prediction reference for the new pictures.

The controller (450) may manage coding operations of the source coder (430), including, for example, setting of parameters and subgroup parameters used for encoding the video data.

Output of all aforementioned functional units may be subjected to entropy coding in the entropy coder (445). The transmitter (440) may buffer the coded video sequence(s) as created by the entropy coder (445) to prepare for transmission via a communication channel (460), which may be a hardware/software link to a storage device which would store the encoded video data. The transmitter (440) may merge coded video data from the video encoder (403) with other data to be transmitted, for example, coded audio data and/or ancillary data streams (sources not shown).

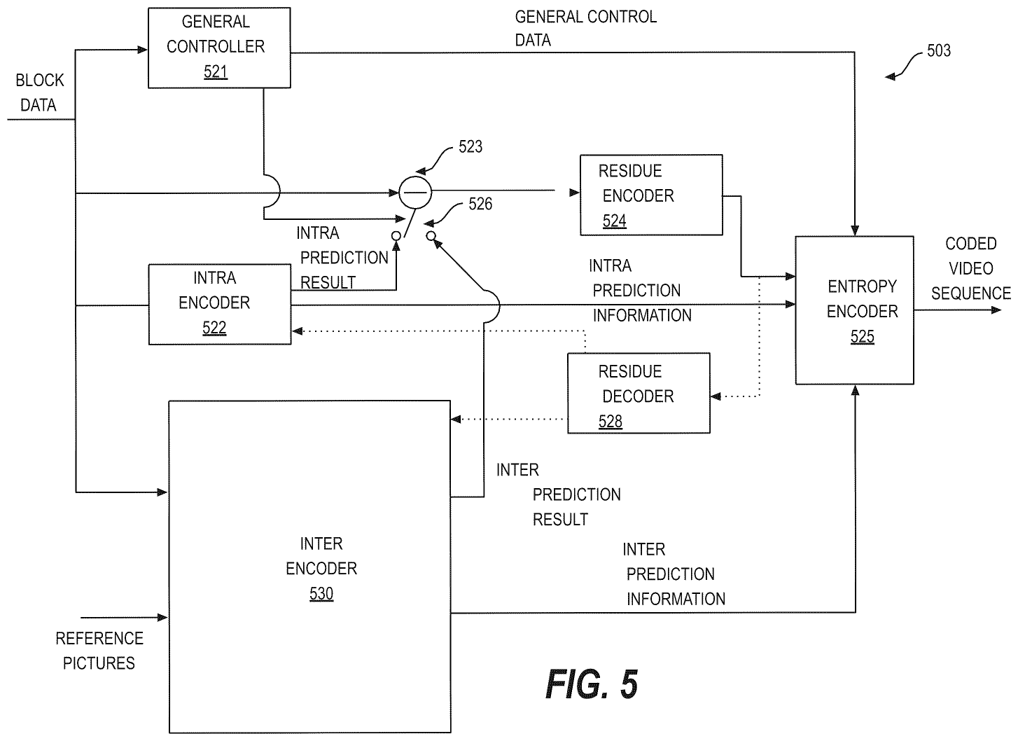

FIG. 5 shows a diagram of a video encoder (503) according to another example embodiment of the disclosure. The video encoder (503) is configured to receive a processing block (e.g., a prediction block) of sample values within a current video picture in a sequence of video pictures, and encode the processing block into a coded picture that is part of a coded video sequence. For example, the video encoder (503) receives a matrix of sample values for a processing block. The video encoder (503) then determines whether the processing block is best coded using intra mode, inter mode, or bi-prediction mode using, for example, rate-distortion optimization (RDO). In the example of FIG. 5, the video encoder (503) includes an inter encoder (530), an intra encoder (522), a residue calculator (523), a switch (526), a residue encoder (524), a general controller (521), and an entropy encoder (525) coupled together. In various example embodiments, the video encoder (503) also includes a residual decoder (528), which performs inverse-transform and generates the decoded residue data.

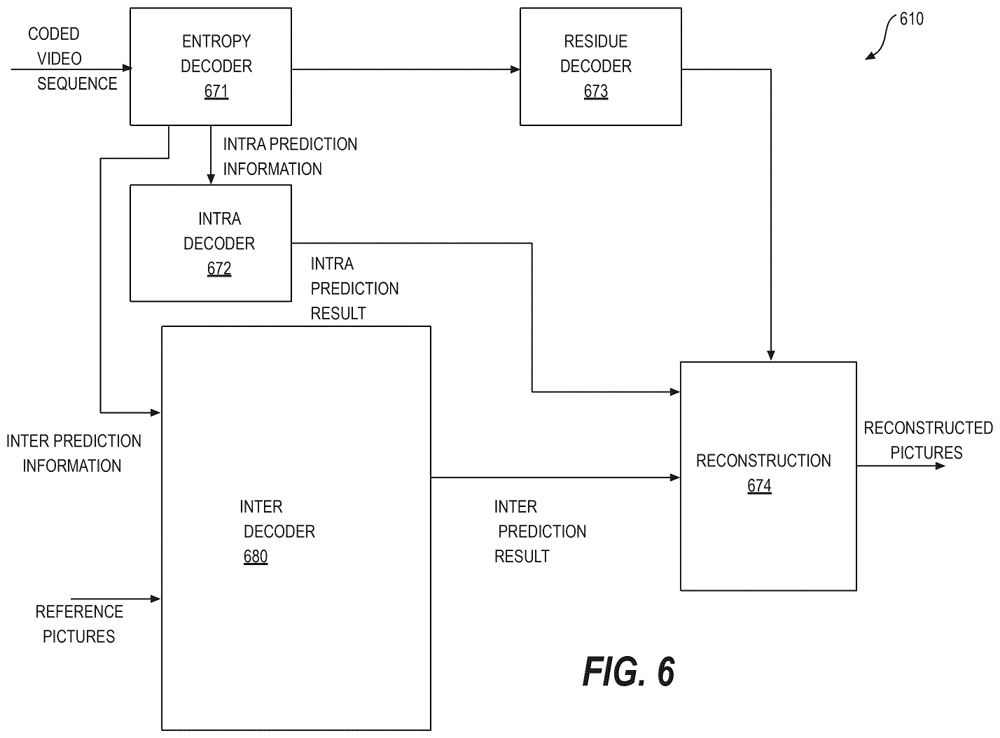

FIG. 6 shows a diagram of an example video decoder (610) according to another embodiment of the disclosure. The video decoder (610) is configured to receive coded pictures that are part of a coded video sequence, and decode the coded pictures to generate reconstructed pictures. In the example of FIG. 6, the video decoder (610) includes an entropy decoder (671), an inter decoder (680), a residual decoder (673), a reconstruction module (674), and an intra decoder (672) coupled together as shown in the example arrangement of FIG. 6.

The entropy decoder (671) can be configured to reconstruct, from the coded picture, certain symbols that represent the syntax elements of which the coded picture is made up. The inter decoder (680) may be configured to receive the inter prediction information, and generate inter prediction results based on the inter prediction information. The intra decoder (672) may be configured to receive the intra prediction information, and generate prediction results based on the intra prediction information. The residual decoder (673) may be configured to perform inverse quantization to extract de-quantized transform coefficients, and process the de-quantized transform coefficients to convert the residual from the frequency domain to the spatial domain. The reconstruction module (674) may be configured to combine, in the spatial domain, the residual as output by the residual decoder (673) and the prediction results (as output by the inter or intra prediction modules as the case may be) to form a reconstructed block forming part of the reconstructed picture as part of the reconstructed video.

Video encoders and/or decoders can be implemented using any suitable technique, e.g., using one or more integrated circuits, or using one or more processors that execute software instructions.

Turning to block partitioning for coding and decoding, general partitioning may start from a base block and may follow a predefined ruleset, particular patterns, partition trees, or any partition structure or scheme. The partitioning may be hierarchical and recursive. Each of the partitions may be referred to as a coding block (CB). A coding block may be a luma coding block or a chroma coding block. The CB tree structure of each color may be referred to as coding block tree (CBT). The coding blocks of all color channels may collectively be referred to as a coding unit (CU). The hierarchical structure of for all color channels may be collectively referred to as coding tree unit (CTU). The partitioning patterns or structures for the various color channels in in a CTU may or may not be the same. In some other example implementations for coding block partitioning, a quadtree structure may be used.

The present disclosure describes various embodiments for spatial resampling mode representation, signaling, coding, and parsing in video coding and/or decoding systems. The embodiments of this application can be applied to cloud technology, smart transportation, assisted driving, and other scenarios involving machine recognition and/or for machine consumption. In some implementations, various methods in the present disclosure may be applicable for video coding for machines (CVM).

In various embodiments or implementations in the present disclosure, a “resample (or resampling)” may also be referred as “upsample (or upsampling” or “upscale (or upscaling)” in a decoding process (in a decoder), which may be a reserve process to “downsample (or downsampling”)” or “downscale (or downscaling)”, which is performed in an encoding process (in an encoder).

In some implementations, the machine recognition scene may include the scene in which the machine interprets the video data and completes related tasks (such as detection, recognition, and other tasks). For example, the video perception features of the target user for video data in the user viewing scenario are different from those of the target machine in the machine recognition scenario. Therefore, the requirements for the quality and resolution of video data in the user viewing scenario are different from those in the machine recognition scenario. The encoding device can also obtain the video content features of the original video data, which may include the rate of change of the video content in the original video data, the amount of video content information, the video resolution of the video frames in the original video data, and the number of video frames played per unit time in the original video data.

In some implementations, the quality requirements of the video data may depend on media application scenario, for example, content change rate requirements and resolution requirements. In some implementations, video content characteristics of the original video data may indicate the video content change rate, and an encoding device can determine the target sampling parameters for sampling and processing the original video data according to the media application scenario and the characteristics of the video content. The sampling parameters can include the sampling mode and the sampling ratio in the sampling mode. Specifically, the target sampling mode may include whether a temporal sampling mode is enabled or not, and/or whether a spatial sampling mode is enabled or not. The temporal sampling mode refers to sampling video frames (related to frame rate), and the spatial sampling mode refers to sampling pixels/lines/blocks in each frame (related to frame resolution). For example, the sampling ratio in the temporal sampling mode may be 2 (i.e., sampling each of every other frames), or 3 (i.e., sampling each of every 3 frames); and the sampling rate in spatial sampling mode may be any value greater than 0, such as 0.5 (i.e., resolution being 0.5 times of its original resolution), or 0.75 (i.e., resolution being 0.75 times of its original resolution), or 2× (i.e., resolution being 2 times of its original resolution).

In some implementations, the sampling parameters (mode and/or ratio/rate) may be determined according to the characteristics of the video content and/or specific scenario. In some implementations, the video-perceptual features may be determined for the video data in the media application scenario, and/or based on the perceptual features of the video and the characteristics of the video content, the sampling ratio/rate under the target sampling mode is determined. The target sampling ratio/rate and target sampling method are determined as the target sampling parameters used for sampling and processing the original video data.

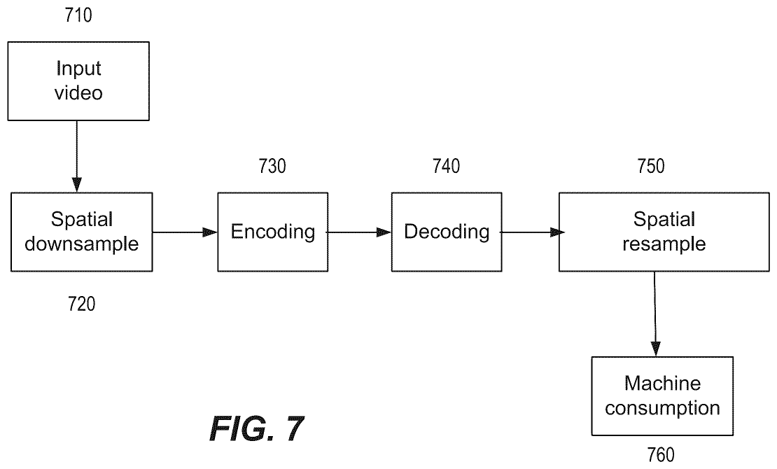

FIG. 7 shows an exemplary embodiment of a spatial resampling-based video data processing pipeline, which may include a portion or all of the following: spatial downsampling 720, encoding 730, decoding 740, and/or spatial resampling (or referred as upsampling or spatial restoration) 750. An input video 710 may be spatial downsampled before encoding, and then downsampled video data may be fed into the encoder to be compressed in video bitstream for transmission, storage, or other processing. In some implementations, the transmitted or retrieved compressed video bitstream is decoded for reconstructing picture sequence; and the reconstructed picture sequence is further spatially resampled (e.g., to its original frame size or a different frame size) for further processing (e.g., for machine consumption 760). Some implementations may not include the spatial resampling unit, wherein the reconstructed video sequence from the decoder is ready directly for application (e.g., for machine consumption). In some implementations, the process in FIG. 7 may include temporal downsample and/or temporal upsampling processes.

In some implementations, an encoding device (e.g., encoder) can sample (e.g., downsample) original video data according to sampling parameters (e.g., the sampling mode and the sampling ratio) to obtain the downsampled video data. The downsampled video data is subsequently encoded to obtain the video coding data corresponding to the original video data. Thus, the data volume of the video coding data can be reduced, and the transmission efficiency of the video coding data can be improved, and the storage space of the video coding data is reduced simultaneously. In some implementations, a decoding device (e.g., decoder) can resample the reconstructed video data, for example, with the same (or different) sampling ratio, so that a same (or different) frame size may be achieved with upsampling/resampling.

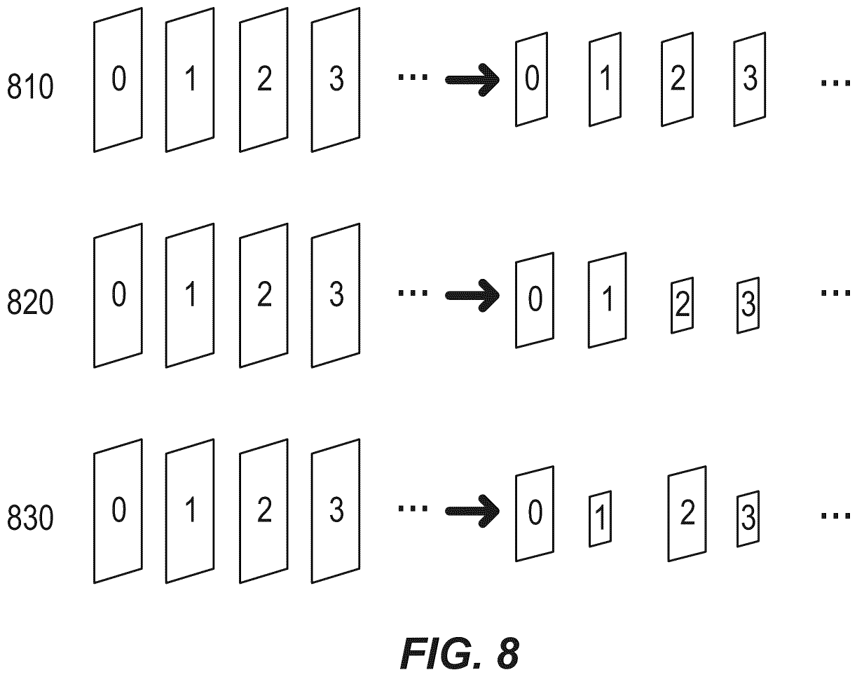

FIG. 8 shows several non-limiting examples of performing spatial downsampling, wherein the original video is downsampled in spatial domain by downsampling the video frames size/resolution either on picture sequence level and/or on picture frame level. In some implementations, the spatial downsampling ratio (or rate) may be 0.5 (or 2), 0.25 (or 4), or any other positive number. In some other implementations, the spatial downsampling ratio (or rate) may be 1, indicating there is no spatial downsampling.

For one example in 810, an original video with frame resolution or size and the downsampling ratio may be 0.5 (or 2) for a picture sequence (frame #0, 1, 2, 3, . . . ), the frame resolution or size is reduced to the half of original frame resolution or size.

For another example in 820, a first picture sequence (frame #0 and 1) may have a downsampling ratio of 0.5 (or 2) and a second picture sequence (frame #2 and 3) may have a downsampling ratio of 0.25 (or 4). Then, the frame resolution or size of the first picture sequence is reduced to the half of original frame resolution or size, and the frame resolution or size of the second picture sequence is reduced to a quarter of original frame resolution or size.

For another example in 830, the downsampling may occur at the frame level (or even at slice/block level). Frame #0 may have a downsampling ratio of 0.5 (or 2), Frame #1 may have a downsampling ratio of 0.25 (or 4), Frame #2 may have a downsampling ratio of 0.5 (or 2), Frame #3 may have a downsampling ratio of 0.25 (or 4). Then, the frame resolution or size of the frame #0 is reduced to the half of original frame resolution or size, the frame resolution or size of the frame #1 is reduced to a quarter of original frame resolution or size, the frame resolution or size of the frame #2 is reduced to the half of original frame resolution or size, the frame resolution or size of the frame #3 is reduced to a quarter of original frame resolution or size.

In some implementations, the spatial downsampling at sequence level (or at frame level or at slice/block level) may have a spatial downsample width or height. For example, the spatial downsample width and height may be 800 and 600 pixels, respectively, when the original frame's width and height are 1600 and 1200 pixels, respectively. For another example, the spatial downsample width and height may be 400 and 300 pixels, respectively, when the original frame's width and height are 1600 and 1200 pixels, respectively.

In some implementations, the spatial downsampling may be enabled for some picture sequence(s), while may not be enabled for some other picture sequence(s). Or the downsampling may be enabled for some frame(s) (or slices/blocks), while may not be enabled for some other frame(s) (or slices/blocks).

In some implementations, the spatial downsampling may use a spatial downsampling filter, which may include one of a bicubic filter, a bilinear filter, a neural network based filter, etc. In some implementations, the spatial downsampling filter may include several categories: a first category being conventional filter including a bicubic filter and a bilinear filter, and a second category being learned filter including a neural network based filter.

In some implementations, the parameters/conditions for spatial downsampling (e.g., filter type, downsampling ratio/rate, downsample width, and/or downsample height) may be encoded as part of the coded video data, so that, when the resampling is needed, the decoder may extract such information for resampling.

In some implementations, the information about the parameters/conditions for spatial downsampling (e.g., filter type, downsampling ratio/rate, downsample width, and/or downsample height) is contained in the video bitstream and signaled to the decoder for upsampling/resampling. When the information signed in the bitstream indicates that the decoded video has been downsampled in spatial domain and/or when upsampling is needed, a decoder is configured to perform the spatial upsampling after the video is reconstructed.

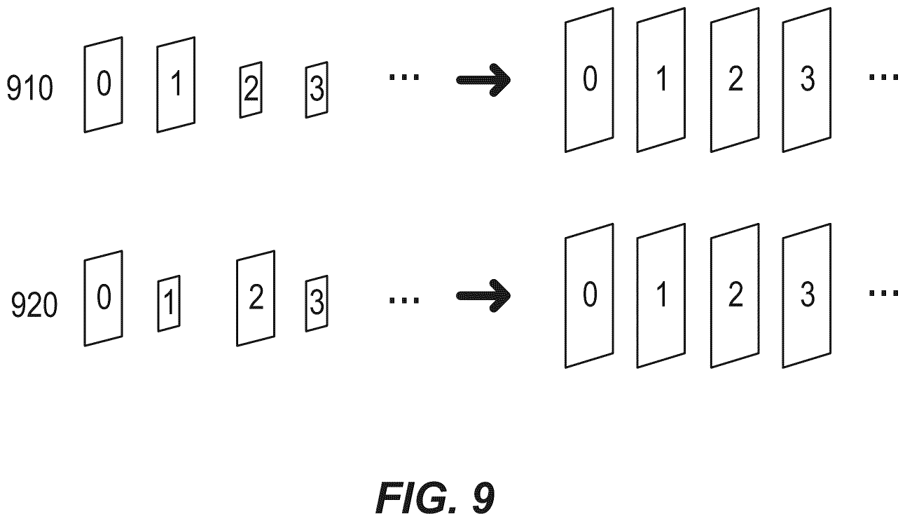

FIG. 9 shows several non-limiting examples of performing spatial upsampling/resampling, wherein the upsampling/resampling may be performed based on a spatial resample filter and/or a spatial resample width and/or a spatial resample depth. The spatial resample filter may correspond to the spatial downsample filter; and/or the spatial resample filter may be the same as the spatial downsample filter. In some implementations, the spatial resample width and depth may be the original frame width and depth, respectively, or different from the original frame width and depth, respectively.

For one example in 910, the first sequence (frame #0 and 1) is resampled to the first sequence's spatial resample width and depth based on the first sequence's spatial resample filter (first filter), and the second sequence (frame #2 and 3) is resampled to the second sequence's spatial resample width and depth based on the second sequence's spatial resample filter (second filter). In some implementations, the first filter may be the same or different from the second filter.

For another example in 920, the first frame (frame #0) is resampled to the first frame's spatial resample width and depth based on the first frame's spatial resample filter (first filter), the second frame (frame #1) is resampled to the second frame's spatial resample width and depth based on the second frame's spatial resample filter (second filter), the third frame (frame #2) is resampled to the third frame's spatial resample width and depth based on the third frame's spatial resample filter (third filter), the fourth frame (frame #3) is resampled to the fourth frame's spatial resample width and depth based on the fourth frame's spatial resample filter (fourth filter). In some implementations, the first, second, third, fourth filters may be the same or different.

Various embodiments and/or implementations described in the present disclosure may be performed separately or combined in any order, and may be applicable for decoding, encoding, or bitstream (or bit streaming). Further, each of the methods (or embodiments), encoder, and decoder may be implemented by processing circuitry (e.g., one or more processors or one or more integrated circuits). The one or more processors execute a program that is stored in a non-transitory computer-readable medium.

The present disclosure describes various embodiments including methods to signal, code, deliver and/or parse spatial downsampling and/or resampling and related information including enabling flag, resampling ratio, downsampling filter; resampling filter; downsample filter type, resample filter type, downsample filter index, resample filter index, downsample width/depth, and/or resample width/depth, etc. in video coding and/or decoding systems. Various embodiments in the present disclosure may be used for not only human but also machine consumptions, for example for Video Coding for Machines (VCM) scenarios as well as in general video coding/decoding systems.

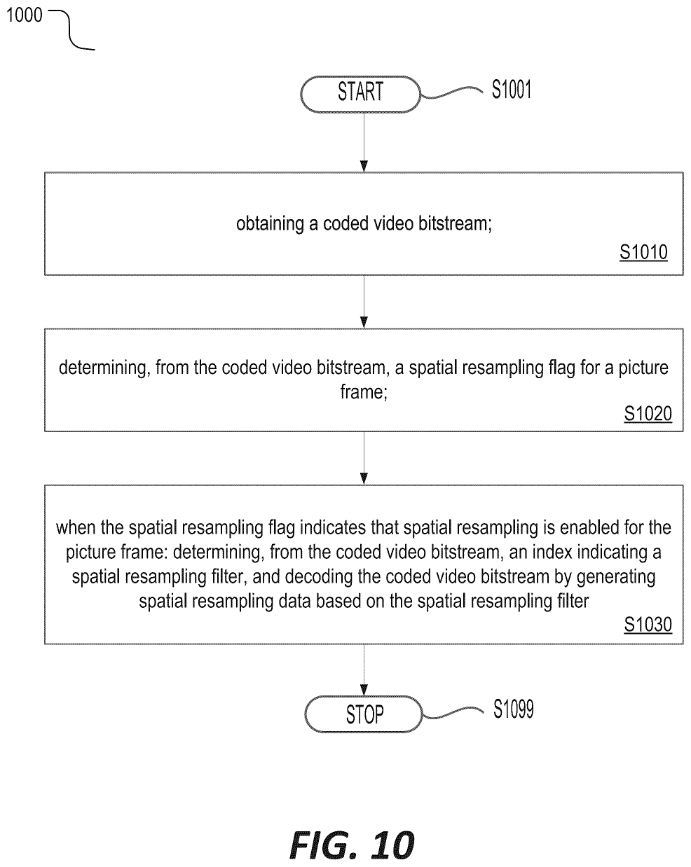

FIG. 10 shows a flow chart of a method 1000 of an exemplary method following the principles underlying the implementations above. The exemplary decoding method flow starts at 1001, and may include a portion or all of the following steps: S1010, obtaining a coded video bitstream; S1020, determining, from the coded video bitstream, a spatial resampling flag for a picture frame; and/or S1030, when the spatial resampling flag indicates that spatial resampling is enabled for the picture frame: determining, from the coded video bitstream, an index indicating a spatial resampling filter, and/or decoding the coded video bitstream by generating spatial resampling data based on the spatial resampling filter. The example method stops at S1099. The method 1000 may be performed by a device comprising a memory storing instructions and a processor in communication with the memory.

In some implementations, in addition to any portion or combination of the embodiments and/or implementations in the present disclosure, the method may further include when the spatial resampling flag indicates that spatial resampling is enabled for the picture frame: determining, by the device from the coded video bitstream, a spatial resample width for the picture frame, and/or determining, by the device from the coded video bitstream, a spatial resample height for the picture frame.

In some implementations, in addition to any portion or combination of the embodiments and/or implementations in the present disclosure, the decoding the coded video bitstream comprises: decoding, by the device, the coded video bitstream by generating the spatial resampling data based on the spatial resampling filter, the spatial resample width, and the spatial resample height.

In some implementations, in addition to any portion or combination of the embodiments and/or implementations in the present disclosure, the index designates the spatial resampling filter used in the decoding process according to a pre-defined table.

In some implementations, in addition to any portion or combination of the embodiments and/or implementations in the present disclosure, when the index is a first value, the spatial resampling filter is not used; when the index is a second value, the spatial resampling filter is a first filter; and/or when the index is a third value, the spatial resampling filter is a second filter.

In some implementations, in addition to any portion or combination of the embodiments and/or implementations in the present disclosure, when the index is a first value, the spatial resampling filter is not used; when the index is a second value, the spatial resampling filter is a pre-defined conventional filter; and/or when the index is a third value, the spatial resampling filter is a pre-defined learned filter.

In some implementations, in addition to any portion or combination of the embodiments and/or implementations in the present disclosure, the method may further include determining, by the device from the coded video bitstream, a spatial resampling filter type; and/or wherein: when the spatial resampling filter type is a first value, the spatial resampling filter is not used; when the spatial resampling filter type is a second value, the spatial resampling filter is one of conventional filters; and/or when the spatial resampling filter type is a third value, the spatial resampling filter is one of learned filters.

In some implementations, in addition to any portion or combination of the embodiments and/or implementations in the present disclosure, when the index is a first value, the spatial resampling filter is a first filter of the spatial resampling filter type; when the index is a second value, the spatial resampling filter is a second filter of the spatial resampling filter type; and/or when the index is a third value, the spatial resampling filter is a third filter of the spatial resampling filter type.

In some implementations, in addition to any portion or combination of the embodiments and/or implementations in the present disclosure, the spatial resampling flag is the sequence-level spatial resampling flag; the picture frame is one frame among a picture sequence; and/or the index is the sequence-level index indicating the spatial resampling filter for the picture sequence.

In some implementations, in addition to any portion or combination of the embodiments and/or implementations in the present disclosure, the spatial resampling flag is the frame-level spatial resampling flag; and/or the index is the frame-level index indicating the spatial resampling filter for the picture frame.

In some implementations, in addition to any portion or combination of the embodiments and/or implementations in the present disclosure, the spatial resampling flag is the slice-level spatial resampling flag; the picture frame comprises one or more slices; and/or the index is the slice-level index indicating the spatial resampling filter for the one or more slices.

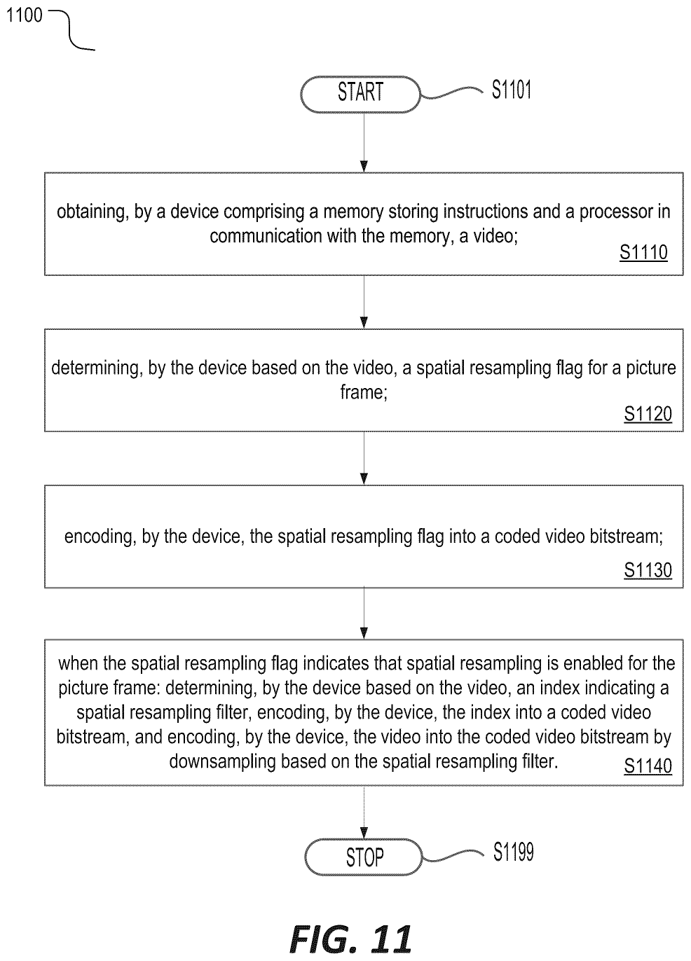

FIG. 11 shows a flow chart of an exemplary method 1100 following the principles underlying the implementations above. The exemplary encoding method flow starts at 1101, and may include a portion or all of the following steps: S1110, obtaining, by a device comprising a memory storing instructions and a processor in communication with the memory, a video; S1120, determining, by the device based on the video, a spatial resampling flag for a picture frame; S1130, encoding, by the device, the spatial resampling flag into a coded video bitstream; and/or S1140 when the spatial resampling flag indicates that spatial resampling is enabled for the picture frame: determining, by the device based on the video, an index indicating a spatial resampling filter, encoding, by the device, the index into a coded video bitstream, and encoding, by the device, the video into the coded video bitstream by downsampling based on the spatial resampling filter. The example method stops at S1199. The method 1100 may be performed by a device comprising a memory storing instructions and a processor in communication with the memory.

In S1140 and in various embodiments or implementations, the spatial resampling flag may be replaced by (or same as) a spatial downsampling flag during encoding process; and/or the spatial resampling filter may be replaced by (or same as) a spatial downsampling filter during encoding process.

In some implementations, in addition to any portion or combination of the embodiments and/or implementations in the present disclosure, the method further includes: when the spatial resampling flag indicates that spatial resampling is enabled for the picture frame: determining, by the device based on the video, a spatial resample width for the picture frame, determining, by the device from the coded video bitstream, a spatial resample height for the picture frame, and/or encoding, by the device, the spatial resampling width and depth into the coded video bitstream.

In some implementations, in addition to any portion or combination of the embodiments and/or implementations in the present disclosure, the index designates the spatial resampling filter used in the decoding process according to a pre-defined table.

In some implementations, in addition to any portion or combination of the embodiments and/or implementations in the present disclosure, when the index is a first value, the spatial resampling filter is not used; when the index is a second value, the spatial resampling filter is a first filter; and/or when the index is a third value, the spatial resampling filter is a second filter.

In some implementations, in addition to any portion or combination of the embodiments and/or implementations in the present disclosure, when the index is a first value, the spatial resampling filter is not used; when the index is a second value, the spatial resampling filter is a pre-defined conventional filter; and/or when the index is a third value, the spatial resampling filter is a pre-defined learned filter.

In some implementations, in addition to any portion or combination of the embodiments and/or implementations in the present disclosure, the method further include: determining, by the device from the coded video bitstream, a spatial resampling filter type; and/or encoding, by the device, the spatial resampling filter type into the coded video bitstream, wherein: when the spatial resampling filter type is a first value, the spatial resampling filter is not used; when the spatial resampling filter type is a second value, the spatial resampling filter is one of conventional filters; and/or when the spatial resampling filter type is a third value, the spatial resampling filter is one of learned filters.

In some implementations, in addition to any portion or combination of the embodiments and/or implementations in the present disclosure, when the index is a first value, the spatial resampling filter is a first filter of the spatial resampling filter type; when the index is a second value, the spatial resampling filter is a second filter of the spatial resampling filter type; and/or when the index is a third value, the spatial resampling filter is a third filter of the spatial resampling filter type.

In some implementations, in addition to any portion or combination of the embodiments and/or implementations in the present disclosure, the spatial resampling flag is the sequence-level spatial resampling flag; the picture frame is one frame among a picture sequence; and/or the index is the sequence-level index indicating the spatial resampling filter for the picture sequence.

In some implementations, in addition to any portion or combination of the embodiments and/or implementations in the present disclosure, the spatial resampling flag is the frame-level spatial resampling flag; and/or the index is the frame-level index indicating the spatial resampling filter for the picture frame.

In some implementations, in addition to any portion or combination of the embodiments and/or implementations in the present disclosure, the spatial resampling flag is the slice-level spatial resampling flag; the picture frame comprises one or more slices; and/or the index is the slice-level index indicating the spatial resampling filter for the one or more slices.

In various embodiment in the present disclosure, a non-transient computer-readable storage medium stores an encoded bitstream of a video, and the encoded bitstream includes a spatial resampling flag for a picture frame; and when the spatial resampling flag indicates that spatial resampling is enabled for the picture frame, an index indicating a spatial resampling filter, so that the encoded bitstream is configured to be decoding by generating spatial resampling data based on the spatial resampling filter.

In some implementations, in addition to any portion or combination of the embodiments and/or implementations in the present disclosure, when the spatial resampling flag indicates that spatial resampling is enabled for the picture frame: the encoded bitstream includes a spatial resample width for the picture frame, and/or the encoded bitstream includes a spatial resample height for the picture frame.

In some implementations, in addition to any portion or combination of the embodiments and/or implementations in the present disclosure, the encoded bitstream is decoded by generating the spatial resampling data based on the spatial resampling filter, the spatial resample width, and the spatial resample height.

In some implementations, in addition to any portion or combination of the embodiments and/or implementations in the present disclosure, the index designates the spatial resampling filter used in the decoding process according to a pre-defined table.

In some implementations, in addition to any portion or combination of the embodiments and/or implementations in the present disclosure, when the index is a first value, the spatial resampling filter is not used; when the index is a second value, the spatial resampling filter is a first filter; and/or when the index is a third value, the spatial resampling filter is a second filter.

In some implementations, in addition to any portion or combination of the embodiments and/or implementations in the present disclosure, the when the index is a first value, the spatial resampling filter is not used; when the index is a second value, the spatial resampling filter is a pre-defined conventional filter; and/or when the index is a third value, the spatial resampling filter is a pre-defined learned filter.

In some implementations, in addition to any portion or combination of the embodiments and/or implementations in the present disclosure, the encoded bitstream includes a spatial resampling filter type; and wherein: when the spatial resampling filter type is a first value, the spatial resampling filter is not used; when the spatial resampling filter type is a second value, the spatial resampling filter is one of conventional filters; and/or when the spatial resampling filter type is a third value, the spatial resampling filter is one of learned filters.

In some implementations, in addition to any portion or combination of the embodiments and/or implementations in the present disclosure, when the index is a first value, the spatial resampling filter is a first filter of the spatial resampling filter type; when the index is a second value, the spatial resampling filter is a second filter of the spatial resampling filter type; and/or when the index is a third value, the spatial resampling filter is a third filter of the spatial resampling filter type.

In some implementations, in addition to any portion or combination of the embodiments and/or implementations in the present disclosure, the spatial resampling flag is the sequence-level spatial resampling flag; the picture frame is one frame among a picture sequence; and/or the index is the sequence-level index indicating the spatial resampling filter for the picture sequence.

In some implementations, in addition to any portion or combination of the embodiments and/or implementations in the present disclosure, the spatial resampling flag is the frame-level spatial resampling flag; and/or the index is the frame-level index indicating the spatial resampling filter for the picture frame.

In some implementations, in addition to any portion or combination of the embodiments and/or implementations in the present disclosure, the spatial resampling flag is the slice-level spatial resampling flag; the picture frame comprises one or more slices; and/or the index is the slice-level index indicating the spatial resampling filter for the one or more slices.

In various embodiments in the present disclosure, a “picture” may refer to a “frame”, or vise versa. A “picture-level” may refer to as “frame-level.” A “picture sequence” may refer to as “frame sequence” or simply as “sequence”.

In various embodiments in the present disclosure, a spatial resampling flag equal to 1 specifies that spatial resampling is enabled. Otherwise the spatial resampling flag equal to 0 specifies that spatial resampling is disabled. A spatial resample width specifies the resampled picture width; and a spatial resample height specifies the resampled picture height. A spatial resample filter index indicates the spatial resampling filter index used to designate the spatial resampling filter in the decoder, for example, according to a pre-defined table.

In various embodiments in the present disclosure, a bicubic filter may include a bicubic interpolation as an extension of cubic spline interpolation (a method of applying cubic interpolation to a data set) for interpolating data points on a two-dimensional regular grid.

In various embodiments in the present disclosure, a first value may be 0, a second value may be 1 or 10, a third value may be 11, and/o a fourth value may be 110.

In some implementations, in addition to any portion or combination of the embodiments and/or implementations in the present disclosure, the method may include to signal, code, deliver and parse spatial resampling and restoration modes and related information including enabling flag, resampling ratio, etc. in video coding and decoding systems.

In some implementations: one example of syntax table and semantics is shown below.

| | Descriptor |
|---|---|
| spatial_resampling( ) { | |
| vcm_spatial_resampling_filter_idx | ue(v) |
| spatial_upsample_width | u(v) |
| spatial_upsample_height | u(v) |
| } | |

Wherein vcm_spatial_resampling_filter_idx may equal to k specifies the spatial resampling filter, as described in the following table.

| k (ue(v) codeword) | Filter |
|---|---|
| 0 | No filter |
| 10 | Bicubic |
| 11 | Bilinear |
| 110 | . . . |
| 111 | . . . |
| . . . | . . . |

In some implementations, the maximum length of the ue(v) codeword may be pre-defined. For example, if it is pre-defined to be equal to 2 or 3, the maximum number of possible filtering options (including no filtering) is 2 or 3 respectively.

In various embodiments in the present disclosure, u(v) may represent a variable-length unsigned integer, where “v” specifies the number of bits used to represent the value; and/or ue(v) may represent an unsigned exponential code (e.g., exponential-Golomb code), where “v” specifies the number of bits used to represent the value. In some implementations, the exponential-Golomb code is a variable-length coding scheme that uses fewer bits for smaller values and more bits for larger values, making it efficient for representing values that are likely to be.

In some implementations: another example of syntax table and semantics is shown below.

| | Descriptor |
|---|---|
| spatial_resampling( ) { | |
| vcm_spatial_resampling_flag | u(1) |
| if ( vcm_spatial_resampling_flag ) { | |
| vcm_spatial_resampling_filter_idx | ue(v) |
| spatial_upsample_width | u(v) |
| spatial_upsample_height | u(v) |
| } | |
| } | |

In some implementations: another example of syntax table and semantics is shown below.

| | Descriptor |
|---|---|
| spatial_resampling( ) { | |
| vcm_spatial_resampling_flag | u(1) |
| if ( vcm_spatial_resampling_flag ) { | |
| spatial_upsample_width | u(v) |
| spatial_upsample_height | u(v) |
| vcm_spatial_resampling_filter_idx | ue(v) |
| } | |
| } | |

Wherein, vcm_spatial_resampling_filter_idx may equal to k specifies the spatial resampling filter, as described in the following table.

| k (ue(v) codeword) | Filter |
|---|---|
| 0 | bicubic |
| 10 | bilinear |
| 11 | . . . |
| 110 | . . . |
| 111 | . . . |
| . . . | . . . |

In some implementations, the maximum length of the ue(v) codeword may be pre-defined. For example, if it is pre-defined to be equal to 2 or 3, then the maximum number of possible filters is 2 or 3 respectively.

In some implementations: another example of syntax table and semantics is shown below.

| | Descriptor |
|---|---|
| spatial_resampling( ) { | |
| vcm_spatial_resampling_filter_idx | ue(v) |
| } | |

Wherein, vcm_spatial_resampling_filter_idx may equal to k specifies the spatial resampling filter, as described in the following table.

| k (ue(v) codeword) | Filter |
|---|---|
| 0 | No filter |
| 10 | Conventional filter |
| 11 | Learned filter |

In some implementations: another example of syntax table and semantics is shown below.

| | Descriptor |
|---|---|
| spatial_resampling( ) { | |
| vcm_spatial_resampling_filter_type | ue(v) |
| vcm_spatial_resampling_filter_idx | ue(v) |
| } | |

wherein, vem_spatial_resampling_filter_type may equal to 0 specifies the spatial resampling filter is not used, vcm_spatial_resampling_filter_type equal to 1 specifies that one of the conventional filter is used, vem_spatial_resampling_filter_type equal to 2 specifies that one of the learned filter is used; and vem_spatial_resampling_filter_idx may equal to k specifies the resampling filter, as described in the following table:

| k (ue(v) codeword) | Filter |
|---|---|
| 0 | Filter 1 |
| 10 | Filter 2 |
| 11 | Filter 3 |

In some implementations, the maximum length of the ue(v) codeword may be pre-defined. For example, if it is pre-defined to be equal to 2 or 3, the maximum number of possible filters is 2 or 3 respectively.

In some implementations: another example of syntax table and semantics is shown below.

| | Descriptor |
|---|---|
| spatial_resampling( ) { | |
| vcm_spatial_resampling_flag | u(1) |
| spatial_upsample_width | u(v) |
| spatial_upsample_height | u(v) |
| } | |

Wherein, vem_spatial_resampling_flag may equal to 0 specifies the spatial resampling filter is not used; and vem_spatial_resampling_flag equals to 1 specifies a predefined spatial resampling filter is used.

In some implementations, any of the methods listed above wherein the spatial_resampling( ) syntax signalling may be performed at sequence level, or may be performed at slice/frame level.

Various embodiments in the present disclosure may include methods for downsampling a video bitstream, which are performed by an encoder, including inverse processes as any portion or all of the processes that are described for the decoder.

Various embodiments in the present disclosure may include methods for encoding and/or decoding a streaming video, which are performed by one or more electronic device (e.g., streaming media player), including any portion or all of the processes for the decoder and/or any portion or all of the processes that are described for an encoder.

Operations above may be combined or arranged in any amount or order, as desired. Two or more of the steps and/or operations may be performed in parallel. Embodiments and implementations in the disclosure may be used separately or combined in any order. Further, each of the methods (or embodiments), an encoder, and a decoder may be implemented by processing circuitry (e.g., one or more processors or one or more integrated circuits). In one example, the one or more processors execute a program that is stored in a non-transitory computer-readable medium.

The techniques described above, can be implemented as computer software using computer-readable instructions and physically stored in one or more computer-readable media. For example, FIG. 2 shows a computer system (200) suitable for implementing certain embodiments of the disclosed subject matter. The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like. The instructions can be executed on various types of computers or components thereof, including, for example, personal computers, tablet computers, servers, smartphones, gaming devices, internet of things devices, and the like, for example, the computer system as shown in FIG. 2.

The computer readable media can have computer code thereon for performing various computer-implemented operations. The media and computer code can be those specially designed and constructed for the purposes of the present disclosure, or they can be of the kind well known and available to those having skill in the computer software arts.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for decoding a coded video bitstream, the method comprising:
obtaining, by a device comprising a memory storing instructions and a processor in communication with the memory, a coded video bitstream;
determining, by the device from the coded video bitstream, a spatial resampling flag for a picture frame; and
when the spatial resampling flag indicates that spatial resampling is enabled for the picture frame:
determining, by the device from the coded video bitstream, an index indicating a spatial resampling filter, and
decoding, by the device, the coded video bitstream by generating spatial resampling data based on the spatial resampling filter.

2. The method according to claim 1, further comprising:
when the spatial resampling flag indicates that spatial resampling is enabled for the picture frame:
determining, by the device from the coded video bitstream, a spatial resample width for the picture frame, and
determining, by the device from the coded video bitstream, a spatial resample height for the picture frame.

3. The method according to claim 2, wherein the decoding the coded video bitstream comprises:
decoding, by the device, the coded video bitstream by generating the spatial resampling data based on the spatial resampling filter, the spatial resample width, and the spatial resample height.

4. The method according to claim 1, wherein:
the index designates the spatial resampling filter used in the decoding process according to a pre-defined table.

5. The method according to claim 1, wherein:
when the index is a first value, the spatial resampling filter is not used;
when the index is a second value, the spatial resampling filter is a first filter; and
when the index is a third value, the spatial resampling filter is a second filter.

6. The method according to claim 1, wherein:
when the index is a first value, the spatial resampling filter is not used;
when the index is a second value, the spatial resampling filter is a pre-defined conventional filter; and
when the index is a third value, the spatial resampling filter is a pre-defined learned filter.

7. The method according to claim 1, further comprising:
determining, by the device from the coded video bitstream, a spatial resampling filter type; and
wherein:
when the spatial resampling filter type is a first value, the spatial resampling filter is not used;
when the spatial resampling filter type is a second value, the spatial resampling filter is one of conventional filters; and
when the spatial resampling filter type is a third value, the spatial resampling filter is one of learned filters.

8. The method according to claim 1, wherein:
when the index is a first value, the spatial resampling filter is a first filter of the spatial resampling filter type;
when the index is a second value, the spatial resampling filter is a second filter of the spatial resampling filter type; and
when the index is a third value, the spatial resampling filter is a third filter of the spatial resampling filter type.

9. The method according to claim 1, wherein:
the spatial resampling flag is the sequence-level spatial resampling flag;
the picture frame is one frame among a picture sequence; and
the index is the sequence-level index indicating the spatial resampling filter for the picture sequence.

10. The method according to claim 1, wherein:
the spatial resampling flag is the frame-level spatial resampling flag; and
the index is the frame-level index indicating the spatial resampling filter for the picture frame.

11. The method according to claim 1, wherein:
the spatial resampling flag is the slice-level spatial resampling flag;
the picture frame comprises one or more slices; and
the index is the slice-level index indicating the spatial resampling filter for the one or more slices.

12. A method for encoding a video, the method comprising:
obtaining, by a device comprising a memory storing instructions and a processor in communication with the memory, a video;
determining, by the device based on the video, a spatial resampling flag for a picture frame;
encoding, by the device, the spatial resampling flag into a coded video bitstream; and
when the spatial resampling flag indicates that spatial resampling is enabled for the picture frame:
determining, by the device based on the video, an index indicating a spatial resampling filter,
encoding, by the device, the index into a coded video bitstream, and
encoding, by the device, the video into the coded video bitstream by downsampling based on the spatial resampling filter.

13. The method according to claim 12, further comprising:
when the spatial resampling flag indicates that spatial resampling is enabled for the picture frame:
determining, by the device based on the video, a spatial resample width for the picture frame,
determining, by the device from the coded video bitstream, a spatial resample height for the picture frame, and
encoding, by the device, the spatial resampling width and depth into the coded video bitstream.

14. The method according to claim 12, wherein:
the index designates the spatial resampling filter used in a decoding process according to a pre-defined table.

15. The method according to claim 12, wherein:
when the index is a first value, the spatial resampling filter is not used;
when the index is a second value, the spatial resampling filter is a first filter; and
when the index is a third value, the spatial resampling filter is a second filter.

16. The method according to claim 12, wherein:
when the index is a first value, the spatial resampling filter is not used;
when the index is a second value, the spatial resampling filter is a pre-defined conventional filter; and
when the index is a third value, the spatial resampling filter is a pre-defined learned filter.

17. The method according to claim 12, further comprising:
determining, by the device from the coded video bitstream, a spatial resampling filter type; and
encoding, by the device, the spatial resampling filter type into the coded video bitstream, wherein:
when the spatial resampling filter type is a first value, the spatial resampling filter is not used;
when the spatial resampling filter type is a second value, the spatial resampling filter is one of conventional filters; and
when the spatial resampling filter type is a third value, the spatial resampling filter is one of learned filters.

18. The method according to claim 12, wherein:
when the index is a first value, the spatial resampling filter is a first filter of the spatial resampling filter type;
when the index is a second value, the spatial resampling filter is a second filter of the spatial resampling filter type; and
when the index is a third value, the spatial resampling filter is a third filter of the spatial resampling filter type.

19. The method according to claim 12, wherein:
the spatial resampling flag is the sequence-level spatial resampling flag;
the picture frame is one frame among a picture sequence; and
the index is the sequence-level index indicating the spatial resampling filter for the picture sequence.

20. A non-transient computer-readable storage medium for storing an encoded bitstream of a video, the encoded bitstream comprising:
a spatial resampling flag for a picture frame; and
when the spatial resampling flag indicates that spatial resampling is enabled for the picture frame, an index indicating a spatial resampling filter, so that the encoded bitstream is configured to be decoded by generating spatial resampling data based on the spatial resampling filter.
